(19) United States
(12) Patent Application Publication
(10) Pub. No.: US 2025/0303908 A1
(43) Pub. Date: Oct. 2, 2025

(54) VEHICLE CONTROL DEVICE, SERVER, AND VEHICLE CONTROL METHOD

(71) Applicants: HYUNDAI MOTOR COMPANY, SEOUL (KR); KIA CORPORATION, SEOUL (KR)

(72) Inventor: Eup Jung Choi, Hwaseong-si (KR)

(73) Assignees: HYUNDAI MOTOR COMPANY, SEOUL (KR); KIA CORPORATION, SEOUL (KR)

(21) Appl. No.: 18/888,442

(22) Filed: Sep. 18, 2024

(30) Foreign Application Priority Data
Mar. 26, 2024 (KR) 10-2024-0041285

(51) Int. Cl. B60L 53/62; B60L 53/65; B60L 53/68

(52) U.S. Cl. CPC B60L 53/62; B60L 53/65; B60L 53/68; B60L 2250/00

(57) ABSTRACT

A vehicle control device, based on a vehicle charging a battery using a charger, obtains a unique ID of the charger, identifies vehicle data including at least one of a time when charging of the battery is started, an SOC of the battery when the charging of the battery is started, the capacity of the battery, a time when the charging of the battery is ended, or an SOC of the battery when the charging of the battery is ended, calculates an actual charging speed including a speed at which the battery is actually charged by the charger based on the vehicle data, and provides a user with information about charging speed data, including at least one of the actual charging speed, or the unique ID of the charger, using at least one of a display of the vehicle, or an audio device of the vehicle.

### CROSS REFERENCE TO RELATED APPLICATIONS

This application claims the benefit of priority to Korean Patent Application No. 10-2024-0041285, filed in the Korean Intellectual Property Office on Mar. 26, 2024, the entire contents of which are incorporated herein by reference.

### TECHNICAL FIELD

The present disclosure relates to a vehicle control device, a server, and a vehicle control method, and more specifically, to a technology for charging a vehicle battery.

### BACKGROUND

Recently, the spread of vehicles that allow users to directly charge their batteries has been increasing. For example, in the case of electric vehicles or plug-in hybrid automobiles, the users are able to directly charge batteries of vehicles.

For the users to charge a vehicle battery, the users are accessing various information related to charging of the battery. For example, the users may obtain information related to a charger for the vehicle battery via various media such as the navigation system of the vehicle, mobile apps, Internet websites or/and the like.

Specifically, the users may receive information about the charging speed of each charger via the above-described media. For example, the users may receive information regarding whether a charger supports an ultra-fast charging mode, a rapid charging mode, or a slow charging mode depending on the charging speed of each charger.

In the past, the users may receive information about charging speeds included in specifications for chargers, rather than a speed at which a vehicle battery is actually charged. Accordingly, there is a problem in that the information about the charging speed provided to the user and the actual charging speed of the vehicle battery are often different due to weather, aging of the charger, and/or the like.

Therefore, there is a need for technology capable of providing information about the speed at which the vehicle is actually charged by each charger.

### SUMMARY

The present disclosure has been made to solve the above-mentioned problems occurring in the prior art while advantages achieved by the prior art are maintained intact.

An aspect of the present disclosure provides a vehicle control device, a server, and a vehicle control method which collect information about a speed at which a vehicle battery is actually charged by each charger, and provide the user with information about an accurate charging speed for each charger based on the collected information.

An aspect of the present disclosure provides a vehicle control device, a server, and a vehicle control method which allow a user to more accurately estimate the time required to charge a vehicle battery using a corresponding charger by providing the user with information about a speed at which the vehicle battery is actually charged for each charger.

An aspect of the present disclosure provides a vehicle control device, a server, and a vehicle control method which collect information about a speed at which a battery of a vehicle is actually charged for each charger, and provide a user with information reflecting the charging speed that varies depending on a change in the age of the charger, season, weather, and/or the like.

An aspect of the present disclosure provides a vehicle control device, a server, and a vehicle control method which determine the performance of a charger by continuously updating information about a speed at which the battery of the vehicle is actually charged for each charger.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control device includes a first memory that stores program instructions, and a first processor that executes the program instructions, and the first processor may, based on a vehicle charging a battery using a charger, obtain a unique ID of the charger, identify vehicle data including at least one of a time when charging of the battery is started, an SOC (State of Charge) of the battery when the charging of the battery is started, the capacity of the battery, a time when the charging of the battery is ended, or an SOC of the battery when the charging of the battery is ended, or any combination thereof, calculate an actual charging speed including a speed at which the battery is actually charged by the charger based on the vehicle data, and provide a user with information about charging speed data, including at least one of the actual charging speed, or the unique ID of the charger, or any combination thereof using at least one of a display of the vehicle, or an audio device of the vehicle, or any combination thereof.

According to an embodiment, the first processor may calculate at least one of a maximum value of actual charging speeds calculated for cycles, a minimum value of the actual charging speeds calculated for cycles, or a mean value of the actual charging speeds calculated for cycles, or any combination thereof based on calculating the actual charging speed for each cycle between the time when the charging of the battery is started and the time when the charging of the battery is ended.

According to an embodiment, the first processor may calculate a mean value of the actual charging speeds over an entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery based on identifying that the actual charging speed for each cycle is not calculated, that the battery is charged while the vehicle's engine turned off, that the charging of the battery is ended abnormally, or that charging speed data is not transmitted to a server due to a communication failure, or any combination thereof.

According to an embodiment, the first processor may obtain the unique ID of the charger from map data used to guide a path of the vehicle.

According to an embodiment, the first processor may transmit the charging speed data to a server, receive charging speed data for each charger including data matching the actual charging speed, the unique ID of the charger, a date on which the server received the charging speed data, and a time at which the server received the charging speed data, and provide the user with information about the charger-specific charging speed data using at least one of the display of the vehicle, or the audio device of the vehicle, or any combination thereof.

According to an aspect of the present disclosure, a server includes a second memory that stores second program instructions, and a second processor that executes the second program instructions, and the second processor may receive, from a vehicle, charging speed data including at least one of an actual charging speed including a speed at which a battery of the vehicle is actually charged by a charger, or a unique ID of the charger, or any combination thereof, and generate charger-specific charging speed data including data matched with the actual charging speed, the unique ID of the charger, a date on which the charging speed data is received, and a time at which the charging speed data is received.

According to an embodiment, the second processor may match external factor information including at least one of season, weather, external temperature, type of vehicle, age of vehicle, or age of charger, or any combination thereof, with the charger-specific charging speed data.

According to an embodiment, the second processor may provide a user with information related to the charger-specific charging speed data via at least one of a navigation system of the vehicle, a mobile application, or a web page, or any combination thereof.

According to an embodiment,, the second processor may receive the charging speed data from the vehicle, the charging speed data including actual charging speeds calculated for cycles, a maximum value of the actual charging speeds calculated for cycles, a minimum value of the actual charging speeds calculated for cycles, a mean value of the actual charging speeds calculated for cycles, a mean value of actual charging speeds over an entire charging time taken from a time charging of the battery is started to a time the charging of the battery is ended.

According to an embodiment, the mean value of actual charging speeds over the entire charging time may be calculated as a value obtained by dividing, by the entire charging time, a value obtained by multiplying a difference between an SOC of the battery at a time when the charging of the battery is ended and an SOC of the battery at a time when the charging of the battery is started, by the capacity of the battery.

According to an embodiment, the second processor may identify an entire charging time taken from a time when charging of the battery is started to a time when the charging of the battery is ended, and receive charger output data from the charger, the charger output data including at least one of the unique ID of the charger, a maximum value of output speeds at which the charger outputs power during the entire charging time, a minimum value of the output speeds at which the charger outputs power during the entire charging time, or a mean value of output speeds at which the charger outputs power during the entire charging time, or any combination thereof.

According to an embodiment, the second processor may compare the charger output data with the charging speed data to determine performance of the charger.

According to an aspect of the present disclosure, a vehicle control method includes identifying, by a vehicle control device, that a vehicle charges a battery using a charger, identifying, by the vehicle control device, vehicle data including a time when charging of the battery is started, an SOC (State of Charge) of a battery when the charging of the battery is started, the capacity of the battery, a time when the charging of the battery is ended, or an SOC of the battery when the charging of the battery is ended, or any combination thereof, calculating, by the vehicle control device, an actual charging speed including a speed at which the battery is actually charged by the charger based on the vehicle data, and providing, by the vehicle control device, a user with information about charging speed data, including at least one of the actual charging speed, or the unique ID of the charger, or any combination thereof using at least one of a display of the vehicle, or an audio device of the vehicle, or any combination thereof.

According to an embodiment, the calculating, by the vehicle control device, the actual charging speed including the speed at which the battery is actually charged by the charger based on the vehicle data may include calculating, by the vehicle control device, at least one of a maximum value of actual charging speeds calculated for cycles, a minimum value of the actual charging speeds calculated for cycles, or a mean value of the actual charging speeds calculated for cycles, or any combination thereof based on calculating the actual charging speed for each cycle between the time at which the charging of the battery is started and the time at which the charging of the battery is ended.

According to an embodiment, the calculating, by the vehicle control device, the actual charging speed including the speed at which the battery is actually charged by the charger based on the vehicle data may include calculating, by the vehicle control device, a mean value of the actual charging speeds over an entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery based on identifying that the actual charging speed for each cycle is not calculated, that the battery is charged while the vehicle's engine turned off, that the charging of the battery is ended abnormally, or that charging speed data is not transmitted to a server due to a communication failure, or any combination thereof.

According to an embodiment, the vehicle control method may further include transmitting, by the vehicle control device, the charging speed data to a server, receiving, by the server, the charging speed data from the vehicle, and generating, by the server, charger-specific charging speed data including data matched with the actual charging speed, the unique ID of the charger, a date on which the charging speed data is received, and a time at which the charging speed data is received.

According to an embodiment, the generating, by the server, of the charger-specific charging speed data including the data matched with the actual charging speed, the unique ID of the charger, the date on which the charging speed data is received, and the time at which the charging speed data is received includes matching, by the server, external factor information including at least one of season, weather, external temperature, type of vehicle, age of vehicle, or age of charger, or any combination thereof, with the charger-specific charging speed data.

According to an embodiment, the vehicle control method may further include providing, by the server, the user with information related to the charger-specific charging speed data via at least one of a navigation system of the vehicle, a mobile application, or a web page, or any combination thereof.

According to an embodiment, the vehicle control method may further include receiving, by the server, charger output data from the charger, the charger output data including at least one of a unique ID of the charger, a maximum value of output speeds at which the charger outputs power during an entire charging time taken from a time when charging of the battery is started to a time when the charging of the battery is ended, a minimum value of the output speeds at which the charger outputs power during the entire charging time, or a mean value of output speeds at which the charger outputs power during the entire charging time, or any combination thereof.

According to an embodiment, the vehicle control method may further include comparing, by the server, the charger output data with the charging speed data to determine performance of the charger.

### BRIEF DESCRIPTION OF THE FIGURES

The above and other objects, features and advantages of the present disclosure will be more apparent from the following detailed description taken in conjunction with the accompanying drawings:

FIG. 1 is a block diagram showing a vehicle control device according to an embodiment of the present disclosure;

FIG. 2 is a block diagram of a server according to an embodiment of the present disclosure;

FIG. 3 is a diagram showing an example in which a vehicle control device, a server, a charger, and a user send and receive data to and from one another, according to an embodiment of the present disclosure;

FIG. 4 is a diagram for describing an example in which a vehicle control device according to an embodiment of the present disclosure transmits data regarding a charging speed for each charger to a server;

FIG. 5 is a diagram for describing an example in which a vehicle control device according to an embodiment of the present disclosure calculates a charging speed if charging of a battery of a vehicle is abnormally ended;

FIG. 6 is a drawing for describing an example in which a server, according to an embodiment of the present disclosure, receives data, from a charger, regarding an output speed calculated for each charging session of the charger;

FIG. 7 is a flowchart for describing a vehicle control device, a server, or a vehicle control method according to an embodiment of the present disclosure; and

FIG. 8 is a diagram showing a computing system related to a vehicle control device, a sever or a vehicle control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. In addition, expression such as “at least one of A, B, or C, or any combination thereof” may include A or B or C or a combination thereof such as AB or ABC and/or the like.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

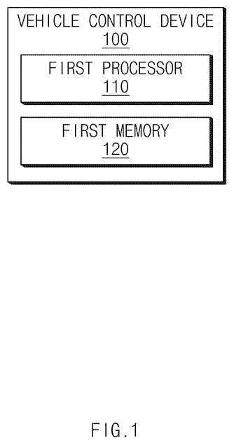

Hereinafter, embodiments of the present disclosure will be described in detail with reference to FIGS. 1 to 8.

FIG. 1 is a block diagram showing a vehicle control device according to an embodiment of the present disclosure;

Referring to FIG. 1, a vehicle control device 100 according to an embodiment of the present disclosure may be implemented inside a vehicle. In this case, the vehicle control device 100 may be integrally formed with internal control units of the vehicle, or may be implemented as a separate device and connected to the control units of the vehicle by separate connection means.

According to an embodiment, the vehicle control device 100 may include a first processor 110 and a first memory 120. The configuration of the vehicle control device 100 shown in FIG. 1 is illustrative, and embodiments of the present invention are not limited thereto. For example, the vehicle control device 100 may further include components not shown in FIG. 1.

According to an embodiment, the first memory 120 may store commands or data. For example, the first memory 120 may include one instruction or two or more instructions that cause the vehicle control device 100 to perform various operations when executed by the first processor 110.

According to an embodiment, the first memory 120 may be implemented as a single chipset with the first processor 110, and may store a variety of information associated with the vehicle control device 100. For example, the first memory 120 may store information about the operation history of the first processor 110.

According to an embodiment, the first memory 120 may include non-volatile memory (Read Only Memory: ROM) and volatile memory (Random Access Memory: RAM). For example, the first memory 120 may store the time when charging of the battery is started, the SOC (State of Charge) of a battery when charging of the battery is started, the capacity of the battery, the time when charging of the battery is ended, and the SOC of the battery when charging of the battery is ended and/or the like.

According to one embodiment, the first processor 110 may obtain a unique ID of a charger based on that the vehicle charges the battery using the charger.

According to an embodiment, a vehicle related to the vehicle control device 100 may include an electric vehicle. The electric vehicle may generate driving power by storing electrical energy using a battery pack and supplying the electrical energy to an electric motor.

According to an embodiment, a vehicle related to the vehicle control device 100 may include a hybrid vehicle. The hybrid vehicle may include an engine, a motor, an engine clutch that selectively connects the engine and the motor, a transmission, a differential gear device, or a battery. Additionally, the hybrid vehicle may include a Hybrid Starter & Generator (HSG) that starts an engine or generates power by the output of the engine, and the HSG may be referred to as an Integrated Starter & Generator (ISG).

According to an embodiment, the vehicle control device 100 may control a vehicle based on a control mode including at least one of an Electric Vehicle mode which utilizes the power of the motor, an Engine mode which utilizes the power of the engine, a Hybrid Electric Vehicle mode which utilizes the power of the engine as the main power source and the power of the motor as an auxiliary power source, or a regenerative braking mode in which a battery is charged by recovering braking and kinetic energy via driving of the motor when the vehicle is traveling (or being operated) by braking or kinetic, or any combination thereof.

A user may use the charger to charge a battery of a vehicle. The charger may be a machine for charging the vehicle's battery and may be installed at a charging station or parking lot. For example, a plurality of chargers may be installed at a charging station, and a user may charge a battery of the vehicle using any one of the plurality of chargers.

According to an embodiment, the charger may be identified via a unique ID. For example, the unique ID of the charger may include a serial number consisting of numbers, letters, special symbols, and/or the like.

According to an embodiment, if the battery of the vehicle is started to be charged by a charger, the first processor 110 may obtain a unique ID of the charger. The first processor 110 may receive data regarding the unique ID of the charger from the charger in a wired or wireless manner.

According to an embodiment, the first processor 110 may obtain the unique ID of the charger from map data used to guide the path of the vehicle.

For example, the first processor 110 may receive map data or navigation information from an external server. The map data may include a variety of geographic information used in vehicle navigation systems or autonomous driving technologies. For example, the map data may include at least one of road network information, traffic information, terrain information, surrounding facility information, lane instructions, or intersection information, or any combination thereof. Specifically, the map data may include information about places useful to users, such as gas stations, charging stations, chargers, accommodations, major tourist attractions, restaurants, and/or the like.

For example, the first processor 110 may obtain the unique ID of the charger from information about charging stations or chargers included in the map data.

According to an embodiment, the first processor 110 may identify vehicle data including a time when charging of the battery is started, an SOC (State of Charge) of a battery when charging of the battery is started, the capacity of the battery, a time when charging of the battery is ended, or an SOC of the battery when charging of the battery is ended, or any combination thereof.

The time when charging of the battery is started may include the date and time when the battery of the vehicle is started charging, and the time when the charging of the battery is ended may include the date and time when charging of the battery of the vehicle is ended.

The capacity of the battery may refer to the amount of electrical energy that is available until the battery is discharged and no current flows. For example, the capacity of the battery may be expressed in units such as kWh (Kilowatthours) or GWh (Gigawatthours). As a specific example, if the battery capacity is 80 kWh, 80 kW of power may be consumed in one hour.

The state of charge (SOC) of the battery may refer to the remaining capacity of the battery of the vehicle. For example, the SOC (State of Charge) of the battery may include a value expressed as a percentage, which is the value obtained by dividing the ‘available capacity of the battery’ by the ‘total capacity of the battery’. For example, SOC when the battery is fully charged may be expressed as 100%.

The SOC (State of Charge) of the battery at the time when charging of the battery is started may refer to the remaining capacity of the battery at the time when charging of the vehicle is started, and the SOC (State of Charge) of the battery at the time when charging of the battery is ended may refer to the remaining capacity of the battery at the time when charging of the vehicle is ended.

According to an embodiment, the first processor 110 may identify, as ‘vehicle data’, data regarding to a time when charging of the battery is started, an SOC (State of Charge) of a battery when charging is started, the capacity of the battery, a time when charging of the battery is ended, or an SOC of the battery when charging of the battery is ended. For example, the first processor 110 may store the identified vehicle data in the first memory 120.

According to an embodiment, the first processor 110 may calculate an actual charging speed including a speed at which the battery is actually charged by a charger, based on the vehicle data. For example, the first processor 110 may calculate the speed at which the the battery of the vehicle is actually charged regardless of the speed at which the charger outputs power.

According to an embodiment, the first processor 110 may identify information about charging speed data including at least one of the actual charging speed, or the unique ID of the charger, or any combination thereof. Furthermore, the first processor 110 may provide a user with information about the charging speed data using at least one of a display of the vehicle, or an audio device of the vehicle, or any combination thereof.

The first processor 110 may display information about the charging speed data on the display of the vehicle. For example, the first processor 110 may display the speed at which the battery of the vehicle is actually charged or the current SOC of the battery on the display of the vehicle.

As another example, the first processor 110 may display both a speed at which the charger outputs power and a speed at which the battery of the vehicle is actually charged on the display of the vehicle. Through this, the user may determine the performance and charging efficiency of the charger.

Additionally, the first processor 110 may inform the user of information about the charging speed data via the audio device. For example, at each preset battery SOC or preset charging time, the speed at which the battery of the vehicle is actually charged or the current SOC of the battery may be informed to the user by voice.

According to an embodiment, the first processor 110 may calculate an actual charging speed at each cycle between the time when charging of the battery is started and the time when charging of the battery is ended.

According to an embodiment, the cycle may include a preset time interval. Specifically, the cycle may be set to a time interval in which a change in charging speed is identified. The cycle may be set to a time interval that reflects the user's pattern. Additionally, the cycle may be set to a time interval directly entered by the user. For example, the cycle may be set in minutes. As a specific example, the cycle may be set to 1 minute.

According to an embodiment, the first processor 110 may continuously calculate an actual charging speeds for each cycle during the time from when charging of the battery is started to when charging of the battery ends.

For example, the first processor 110 may continuously calculate an actual charging speed for each cycle while the battery of the vehicle is being charged. As a specific example, if the battery of the vehicle has been charged for 30 minutes and the cycle is 1 minute, the actual charging speed may be calculated 29 times.

According to an embodiment, the first processor 110 may calculate the maximum value among the actual charging speeds calculated for cycles, the minimum value among the actual charging speeds calculated for cycles, and the mean value of the actual charging speeds calculated for cycles.

According to an embodiment, while the battery of the vehicle is being charged, the actual charging speed may continuously vary. For example, the first processor 110 may identify actual charging speeds that vary during the time the battery of the vehicle is charging, and calculate the fastest speed among the actual charging speeds as the maximum value. Additionally, the first processor 110 may identify the slowest speed among the actual charging speeds as the minimum value.

According to an embodiment, the first processor 110 may identify actual charging speeds that vary while the battery of the vehicle is being charged, and calculate the mean value of the identified actual charging speeds. For example, if the actual charging speeds calculated for cycles are 30 kW, 35 kW, 40 kW, and 55 kW while the battery of the vehicle is charging, the mean value of the actual charging speeds may be calculated as 40 kW.

According to an embodiment, the first processor 110 may provide the user with the maximum value among the actual charging speeds calculated for cycles, the minimum value among the actual charging speeds calculated for cycles, and the mean value of the actual charging speeds calculated for cycles.

According to an embodiment, if the first processor 110 fails to calculate the actual charging speed for each cycle, if the battery is charged while the vehicle's engine turned off, if charging of the battery is ended abnormally, or if charging speed data is not transmitted to a server due to a communication failure, the first processor 110 may calculate the mean value of the actual charging speeds over the entire charging time.

For example, the first processor 110 may calculate the mean value of the actual charging speeds over the entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery.

As a specific example, if the SOC of the battery when charging of the battery is started is 30%, the SOC of the battery when charging is ended is 100%, the entire charging time taken from a time when charging of the battery is started to a time when the charging of the battery is ended is 10 hours, and the capacity of the battery of the vehicle is 60 kWh, the first processor 110 may calculate the mean value of the actual charging speed as follows.

The first processor 110 may calculate the difference between the SOC of the battery (100%) at the time when charging of the battery is ended and the SOC (30%) of the battery at the time when charging of the battery is started as 70%, calculate “42 kWh” by multiplying “0.7”, corresponding to 70%, by “60 kWh”, the capacity of the battery of the vehicle, and calculate “4.2 kWh” by dividing “42 kWh” by “10 hours”, the entire charging time. As a result, the first processor 110 may calculate “4.2 kWh” as the mean value of the actual charging speeds over the entire charging time. That is, in the above example, the mean value of the actual charging speeds over the entire charging time may be calculated as 4.2 kWh.

For example, due to internal or external factors of the vehicle control device, the first processor 110 may not be able to identify the actual charging speed calculated for each cycle. In this case, the first processor 110 may calculate the mean value of the actual charging speeds over the entire charging time as described above and identify the mean value as the actual charging speed.

For example, if the battery is charged while the vehicle's engine is being turned off, the first processor 110 may not be able to calculate the charging speed for each cycle. In this case, the first processor 110 may calculate the mean value of the actual charging speeds over the entire charging time as described above and identify the mean value as the actual charging speed.

For example, if charging of the battery is ended abnormally, the charging speed may not be calculated for each cycle, or the collection of the calculated charging speeds may be unstable. In this case, the first processor 110 may calculate the mean value of the actual charging speeds over the entire charging time as described above and identify the mean value as the actual charging speed.

For example, the first processor 110 may not be able to transmit the charging speed data to the server due to a communication failure. In this case, the first processor 110 may calculate the mean value of the actual charging speeds over the entire charging time as described above and identify the mean value as the actual charging speed. Further, the first processor 110 may transmit the mean value of the actual charging speeds for the calculated entire charging time to the server.

According to an embodiment, the first processor 110 may transmit charging speed data to the server. As described above, the charging speed data may include the actual charging speed and the unique ID of the charger.

According to an embodiment, the first processor 110 may transmit data to the server or receive data from the server via a communication circuit. For example, the vehicle and the server may each include a communication circuit, and the vehicle and the server may exchange data with each other via their respective communication circuits.

For example, the communication circuit may include circuitry for wireless Internet access. For example, the communication circuit may be connected to a wireless communication network of a wireless communication provider and utilize wireless communications such as 3G, LTE (Long Term Evolution), LTE-A (Long Term Evolution-Advanced), 5G (fifth generation mobile communications) and/or the like. Additionally, the communication circuit may be mounted on a telematics unit and may include an RF (Radio Frequency) antenna and a communication control module.

According to an embodiment, if the server receives charging speed data from the first processor 110, the server may identify a date on which the server received the charging speed data and a time at which the server received the charging speed data. For example, the server may match charger-specific charging speed data with the date and time on which the charging speed data has been received and store the charger-specific charging speed data in association with the date and time on which the charging speed data has been received in a database.

As another example, the first processor 110 may transmit charging speed data to the server while also transmitting information about the vehicle. The information about the vehicle may include the type of the vehicle, the age of the vehicle, and/or the like. For example, the server may match store the actual charging speed included in the charging speed data with information about the vehicle and store the actual charging speed included in the charging speed data in association with information about the vehicle in a database. In other words, the actual charging speeds may be different depending on the type of vehicle or the age of the vehicle even though the the actual charging speeds are calculated from the same charger. Therefore, the server may store charging speed data containing the actual charging speed matched with information about the vehicle in the database.

According to one embodiment, the server may identify data matched with the actual charging speed, the unique ID of the charger, the date on which the server received the charging speed data, and the time at which the server received the charging speed data, as charger-specific charging speed data.

For example, the server may collect charging speed data for each charger by matching charging speed data received from the vehicle with the unique ID of the charger used by the vehicle. The server may identify data collected by charger as charger-specific charging speed data and store it in a database.

According to an embodiment, the first processor 110 may receive charger-specific charging speed data, which includes data matched with the actual charging speed, the unique ID of the charger, the date on which the server received the charging speed data, and the time at which the server received the charging speed data.

According to an embodiment, the first processor 110 may provide a user with information about charger-specific charging speed data received from the server using at least one of the display of the vehicle, or the audio device of the vehicle, or any combination thereof.

The first processor 110 may provide the user with information about charging speed data for chargers located on the path of the vehicle. For example, the first processor 110 may display information about the actual charging speed of a corresponding charger on an indicator related to the charger located on the path displayed on the display. Additionally, if the vehicle approaches a charger located on the path by a preset distance, the first processor 110 may provide information about the actual charging speed of the charger via an audio device.

According to an embodiment, the user may select a charger that meets the user's needs in consideration of the speed at which the vehicle is actually be charged by using information about charger-specific charging speed data from the vehicle.

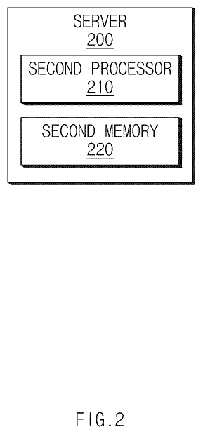

FIG. 2 is a block diagram of a server according to an embodiment of the present disclosure.

Referring to FIG. 2, a server 200 according to an embodiment of the present disclosure may include a second processor 210 and a second memory 220. The configuration of the server 200 shown in FIG. 2 is illustrative, and embodiments of the present disclosure are not limited thereto. For example, the server 200 may further include components not shown in FIG. 2.

According to an embodiment, the second memory 220 may store commands or data. For example, the second memory 220 may include one instruction or two or more instructions that cause the server 200 to perform various operations when executed by the second processor 210. For example, the second memory 220 may function as a server database.

According to an embodiment, the second memory 220 may be implemented as a single chipset with the second processor 210, and may store a variety of information associated with the server 200. For example, the second memory 220 may store information about the operation history of the second processor 210.

According to an embodiment, the second memory 220 may include non-volatile memory (Read Only Memory: ROM) and volatile memory (Random Access Memory: RAM). For example, the actual charging speed, the unique ID of the charger, and/or the like may be stored in the second memory 220.

Hereinafter, the charging speed data and the charger-specific charging speed data for the server 200 of FIG. 2 according to an embodiment may correspond to the charging speed data and the charger-specific charging speed data for the vehicle control device 100 described in FIG. 1.

According to an embodiment, the second processor 210 may receive, from a vehicle, charging speed data including at least one of an actual charging speed at which the battery of the vehicle is actually charged by a charger, or a unique ID of the charger, or any combination thereof.

According to an embodiment, the second processor 210 may generate charger-specific charging speed data including data matched with the unique ID of the charger, the date on which the charging speed data is received, and the time at which the charging speed data is received.

For example, if the second processor 210 receives charging speed data from the vehicle, the second processor 210 may identify the date on which the second processor 210 received the charging speed data and the time at which the second processor 210 received the charging speed data. The second processor 210 may generate charger-specific charging speed data that is matched with the date and time on and at which the charging speed data is received, and may store the charger-specific charging speed data in a database.

According to an embodiment, the second processor 210 may match, with the charger-specific charging speed data, external factor information including at least one of season, weather, external temperature, type of vehicle, age of vehicle, or age of charger, or any combination thereof.

According to an embodiment, the actual charging speed included in the charger-specific charging speed data may be affected by season, weather, external temperature, type of vehicle, age of the vehicle, or age of the charger.

For example, if the temperature is low, the activity of lithium ions in the electrolyte of the battery of the vehicle decreases, which may reduce the charging speed. Accordingly, if the battery is charged in cold weather, the actual charging speed of the battery of the vehicle may be slower than that when the battery is charged in high temperature weather. Likewise, in winter, if temperatures are low, the actual charging speed of the battery may be slower than that in summer where temperatures are high.

For example, the speed at which the battery of the vehicle is actually charged may vary depending on the type or age of the vehicle. The acceptable charging speed may vary depending on the type of vehicle. Specifically, the actual charging speeds of a vehicle capable of fast charging and a vehicle incapable of fast charging may be different even if the battery is charged by the same charger. Additionally, even if the vehicle is of the same type, a vehicle of a recent model year may be capable of fast charging, and a vehicle of an older model year may be incapable of fast charging. Accordingly, even if the battery is charged by the same charger, the actual charging speed may vary depending on the age of the vehicle.

For example, the speed at which the battery of the vehicle is actually charged may vary depending on the age of the charger. The older the charger is, the output speed may decrease due to the aging of the charger. Accordingly, if the battery is charged by the same charger, the actual charging speed of the battery of the vehicle may be slow if the battery is charged by an older model charger.

According to an embodiment, the second processor 210 may match the above-described external factor information (season, weather, external temperature, type of vehicle, age of vehicle, age of charger) with charger-specific charging speed data and store it in the database.

According to an embodiment, the second processor 210 may provide a user with information related to charger-specific charging speed data which is matched with the above-described external factor information (season, weather, external temperature, type of vehicle, age of vehicle, age of charger).

According to an embodiment, the second processor 210 may provide the user with information related to charger-specific charging speed data via at least one of the navigation system of the vehicle, a mobile application, or a web page, or any combination thereof.

For example, the second processor 210 may provide the user with information corresponding to the type of vehicle the user has, the age of the vehicle, or the season, weather, and external temperature at the time when the user identifies information related to charging speed data for each charger, among pieces of information related to charger-specific charging speed data.

For example, the second processor 210 may display information related to the charger-specific charging speed data on the navigation system of the vehicle. Furthermore, the second processor 210 may provide information related to the charger-specific charging speed data to a mobile application or web page. Accordingly, the user may identify the charging speed for each charger via a navigation system of the vehicle, a mobile application, or a web page.

According to an embodiment, the second processor 210 may receive charging speed data including data related to actual charging speeds calculated for each cycle from the vehicle.

For example, the charging speed data received from the vehicle by the second processor 210 may include the maximum value among the actual charging speeds calculated for cycles, the minimum value among the actual charging speeds calculated for cycles, the mean value of the actual charging speeds calculated for cycles, and the mean value of the actual charging speeds over the entire charging time taken from the time when the charging of the battery is started to the time when the charging of the battery is ended.

According to an embodiment, the charging speed data received from the vehicle by the second processor 210 may be understood as the charging speed data calculated by the first processor 110 of the vehicle control device 100 described above with reference to FIG. 1.

For example, the mean value of the actual charging speeds over the entire charging time may be calculated as a value obtained by dividing, by the entire charging time, a value obtained by multiplying the difference between the SOC of the battery when charging of the battery is ended and the SOC of the battery when charging is started, by the capacity of the battery.

For example, if the second processor 210 fails to calculate the actual charging speed for each cycle, if the battery is charged while the vehicle's engine turned off, if charging of the battery is terminated abnormally, or if charging speed data is not transmitted to a server due to a communication failure, the second processor 210 may receive the mean value of the actual charging speeds over the entire charging time, from the vehicle.

According to an embodiment, the second processor 210 may identify the entire charging time taken from the time when the charging of the battery is started to the time when the charging of the battery is ended.

According to an embodiment, the second processor 210 may receive data related to the power output by the charger from the charger. For example, each of the charger and the server may include a communication circuit, and the charger may receive data from the server via the communication circuit.

According to an embodiment, the second processor 210 may receive, from the charger, charger output data including at least one of the unique ID of the charger, the maximum value among the output speeds at which the charger outputs power during the entire charging time, the minimum value among the output speeds at which the charger outputs power during the entire charging time, or the mean value of the output speeds at which the charger outputs power during the entire charging time, or any combination thereof.

For example, the output speeds at which the charger outputs power may be measured regardless of the speeds at which the battery of the vehicle is actually charged via the charger. Therefore, the output speed received from the charger and the speed at which the battery of the vehicle is actually charged may be different.

According to an embodiment, the second processor 210 may match the output speeds received from the charger among the charger output data with the unique ID of the charger and store the output speeds received from the charger in association with the unique ID of the charger.

According to an embodiment, the second processor 210 may match charger output data received from the charger with charging speed data received from the vehicle. For example, the second processor 210 may match charger output data received from the charger with charging speed data received from the vehicle, based on the date and time when the battery of the vehicle is charged.

According to an embodiment, the second processor 210 may determine the performance of the charger by comparing the charger output data and the charging speed data. For example, if a difference between the output speed included in the charger output data and the actual charging speed of the battery included in the charging speed data exceeds a threshold, it may be determined that the performance of the charger has been reduced. Furthermore, the second processor 210 may determine when to replace the charger based on the degree to which the performance of the charger has decreased.

According to an embodiment, the second processor 210 may provide information related to the performance of the charger to the user.

According to an embodiment, the user may select a charger that meets the user's needs using information about charger-specific charging speed data provided by the server 200 via the navigation system of the vehicle, the mobile application, or the web page.

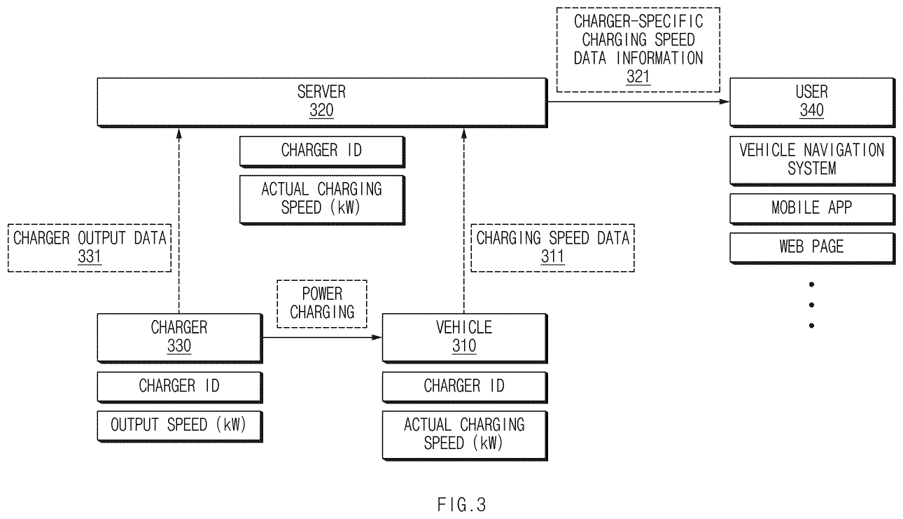

FIG. 3 is a diagram showing an example in which a vehicle control device, a server, a charger, and a user send and receive data to and from one another, according to an embodiment of the present disclosure.

According to an embodiment, a user 340 may charge a battery of a vehicle 310 using a charger 330. The charger 330 may provide electrical energy to the battery of the vehicle 310. The battery of the vehicle 310 may be charged by the charger 330.

According to an embodiment, the vehicle 310 may obtain a charger ID. The charger ID may include a unique ID that identifies the charger 330. For example, the vehicle 310 may obtain the charger ID from map data. In another example, the vehicle 310 may receive data associated with the charger ID from the charger 330.

According to an embodiment, the vehicle 310 may calculate a speed at which the battery is actually being charged by the charger 330 (an actual charging speed). The vehicle 310 may transmit charging speed data 311, including the actual charging speed and the charger ID, to a server 320.

According to an embodiment, the server 320 may receive, from the vehicle 310, the charging speed data 311 including at least one of the actual charging speed, or the charger ID, or any combination thereof.

According to an embodiment, the server 320 may generate charger-specific charging speed data 321 that includes data matched with the charger ID, the date on which the charging speed data 311 is received, and the time at which the charging speed data 311 is received.

In addition, according to an embodiment, the server 320 may match external factor information to the charger-specific charging speed data 321. The external factor information may include season, weather, outside temperature, type of vehicle, age of the vehicle, or age of the charger.

According to an embodiment, the server 320 may receive charger output data 331 from the charger 330 related to the power output by the charger 330.

For example, the charger output data 331 may include the ID of the charger, the maximum value of the output speeds at which the charger outputs power during the entire charging time, the minimum value of the output speeds at which the charger outputs power during the entire charging time, and an mean value of the output speeds at which the charger outputs power during the entire charging time.

According to an embodiment, the server 320 may store the output speeds of the chargers of the charger output data 331 with the charger IDs of the corresponding chargers 330 and store the output speeds of the chargers in association with the charger IDs of the corresponding chargers 330 in a database.

According to an embodiment, the server 320 may provide information regarding the charger-specific charging speed data 321 to the user 340.

For example, the server 320 may provide the information regarding the charger-specific charging speed data 321 to the user 340 via at least one of the vehicle 310's navigation system, a mobile application, or a web page, or any combination thereof.

Referring to FIG. 3, according to an embodiment, the user 340 may be provided with information regarding an actual charging speed for each charger, allowing the user 340 to more accurately estimate the time required to charge the battery of the vehicle 310.

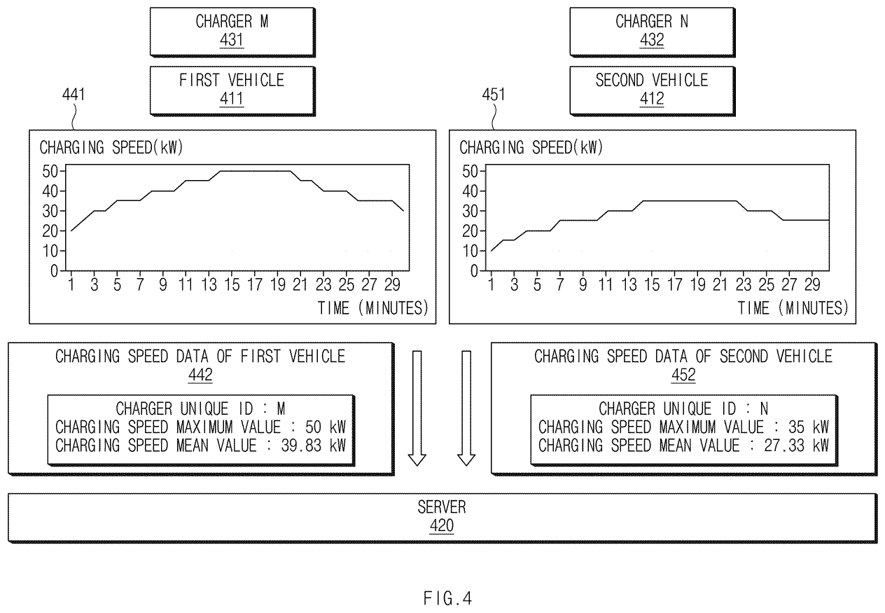

FIG. 4 is a diagram for describing an example in which a vehicle control device according to an embodiment of the present disclosure transmits data regarding a charging speed for each charger to a server.

According to an embodiment, a first vehicle 411 may charge a battery of the vehicle using a charger “M” 431 and a second vehicle 412 may charge a battery of the vehicle using a charger “N” 432.

According to an embodiment, the first vehicle 411 may identify a charging speed 441 that varies over time. For example, the speed at which the battery of the first vehicle 411 is actually charged may gradually increase over time from the time the charging is started. In addition, the speed at which the battery of the first vehicle 411 is actually charged may gradually decrease as the time to end charging approaches.

According to an embodiment, the first vehicle 411 may calculate charging speed data 442 associated with a speed at which the battery is actually charged (actual charging speed). For example, the charging speed data 442 may include the unique ID of the charger “M” 431, the maximum value of the actual charging speeds, the minimum value of the actual charging speed, or a mean value of the actual charging speeds.

For example, the first vehicle 411 may calculate the actual charging speed on a per-cycle basis. The first vehicle 411 may identify actual charging speeds that vary while the battery of the vehicle is being charged, and may calculate the maximum value of the actual charging speeds, the minimum value of the actual charging speeds, or a mean value of the actual charging speeds based on the corresponding actual charging speeds.

According to an embodiment, the first vehicle 411 may transmit the calculated charging speed data 442 to a server 420.

According to an embodiment, the second vehicle 412 may identify a charging speed 451 that varies over time. For example, the speed at which the battery of the second vehicle 412 is actually charged may gradually increase over time from the time the charging is started. Furthermore, the speed at which the battery of the second vehicle 412 is actually charged may gradually decrease as the time at which charging is ended approaches.

According to an embodiment, the second vehicle 412 may calculate charging speed data 452 associated with a speed at which the battery is actually charged (actual charging speed). For example, the charging speed data 452 may include the unique ID of the charger “N” 432, the maximum value of the actual charging speeds, the minimum value of the actual charging speeds, or the mean value of the actual charging speeds.

For example, the second vehicle 412 may calculate an actual charging speed for each cycle. The second vehicle 412 may identify actual charging speeds that vary while the battery of the vehicle is being charged, and may calculate the maximum value of the actual charging speeds, the minimum value of the actual charging speeds, or the mean value of the actual charging speeds based on the corresponding actual charging speeds.

According to an embodiment, the second vehicle 412 may transmit the calculated charging speed data 442 to the server 420.

According to an embodiment, the server 420 may distinguish between the charging speed data 442 associated with the charger “M” 431 received from the first vehicle 411 and the charging speed data 452 associated with the charger “N” 432 received from the second vehicle 412 and store them in a database. For example, charger-specific charging speed data may be collected using the charging speed data 442 associated with the charger “M” 431 and the charging speed data 452 associated with the charger “N” 432.

The above description of FIG. 4 may be equally applicable if the first vehicle 411 and the second vehicle 412 are the same vehicle as one embodiment. In other words, the example described above may be applicable if the same vehicle charges a battery using the charger “M” 431 and the charger “N” 432 which are different from each other.

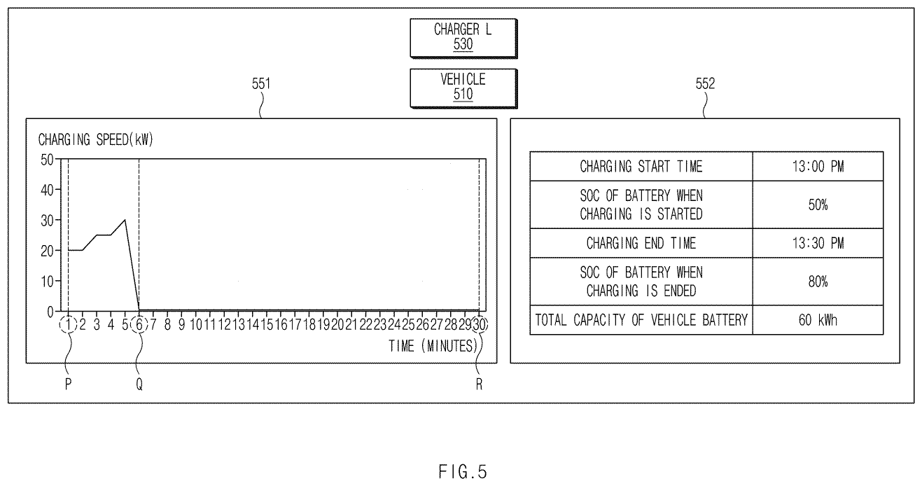

FIG. 5 is a diagram for describing an example in which a vehicle control device according to an embodiment of the present disclosure calculates a charging speed if charging of a battery of a vehicle is abnormally ended.

FIG. 5 according to an embodiment may illustrate an example where a vehicle 510 charges a battery of the vehicle 510 using a charger “L” 530. The vehicle 510 may calculate, via the vehicle control device, a speed at which the battery is actually being charged.

FIG. 5 according to an embodiment includes an example of a charging speed graph 551 if charging of the battery is ended abnormally. Further, FIG. 5 includes an example of a table 552 showing information for calculating a mean value of actual charging speeds over the entire charging time if charging is abnormally ended.

The charging speed graph 551 included in FIG. 5, according to an embodiment, may indicate a time point “P” at which charging of the battery of the vehicle 510 is started, a time point “Q” at which charging of the battery of the vehicle 510 is ended abnormally, and a time point “R” at which charging of the battery of the vehicle 510 is ended.

For example, referring to the charging speed graph 551 included in FIG. 5, the charging speed may not be calculated after the charging of the battery of the vehicle 510 has been stopped. In this case, the vehicle control device may not be able to calculate an actual charging speed for each cycle.

According to an embodiment, if the vehicle control device fails to calculate the actual charging speed for each cycle, the vehicle control device may identify a mean value of the actual charging speeds over the entire charging time as the actual charging speed.

For example, the vehicle control device may calculate the mean value of the actual charging speeds over the entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery.

As a specific example, referring to the table 552 included in FIG. 5, if the SOC of the battery when charging of the battery is started is 50%, the SOC of the battery when charging is ended is 80%, the entire charging time taken from a time when charging of the battery is started to a time when the charging of the battery is ended is 0.5 hours, and the capacity of the battery of the vehicle is 60 kWh, the vehicle control device may calculate the mean value of the actual charging speed as follows.

The vehicle control device of the vehicle 510 may calculate the difference between the SOC of the battery (80%) at the time when charging of the battery is ended and the SOC (50%) of the battery at the time when charging of the battery is started as 30%, calculate “18 kWh” by multiplying “0.3”, corresponding to 30%, by “60 kWh”, the capacity of the battery of the vehicle, and calculate “36 kWh” by dividing “18 kWh” by “0.5 hours”, the entire charging time.

As a result, the vehicle control device may calculate “36 kWh” as the mean value of the actual charging speeds over the entire charging time. That is, in the example shown in FIG. 5, the mean value of the actual charging speeds over the entire charging time may be calculated as 36 kWh.

According to an embodiment, the vehicle control device may transmit, to a server, charging speed data including the calculated mean value of the actual charging speeds. If receiving the charging speed data, the server may collect the charging speed data by charging stations and store the charging speed data in a database.

Referring to FIG. 5, according to an embodiment, if the vehicle control device fails to calculate the actual charging speed calculated for each cycle due to internal factors or external factors, the vehicle control device may calculate an mean value of the actual charging speeds over the entire charging time as the actual charging speed.

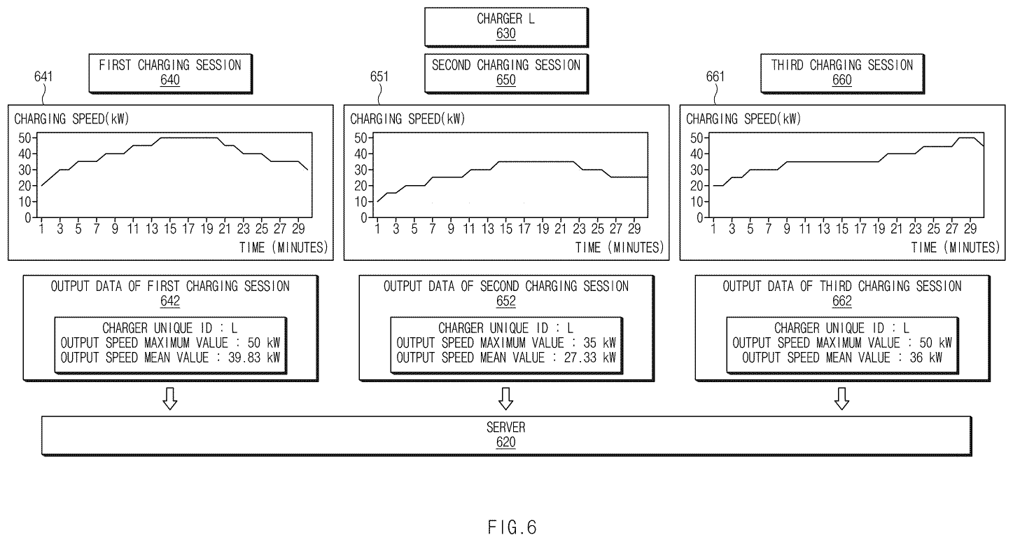

FIG. 6 is a drawing for describing an example in which a server, according to an embodiment of the present disclosure, receives data, from a charger, regarding an output speed calculated for each charging session of the charger.

According to an embodiment, FIG. 6 may illustrate an example where a vehicle charges a battery using charger “L” 630.

According to an embodiment, the charger “L” 630 may distinguish data generated from the time at which charging of the battery is started to the time at which charging is ended in the units of charging session. For example, as shown in FIG. 6, if the battery is charged three times, the charger “L” 630 may distinguish charging sessions as a first charging session 640, a second charging session 650, and a third charging session 660.

According to an embodiment, FIG. 6 shows the first charging session 640, the second charging session 650, and the third charging session 660 of the charger “L” 630. For example, the first charging session 640, the second charging session 650, and the third charging session 660 may be for charging batteries of different vehicles respectively, or may be for charging the battery of the same vehicle three times.

According to an embodiment, the charger “L” 630 may identify a speed at which the charger “L” 630 outputs power to the battery of the vehicle (output speed). The charger “L” 630 may identify an output speed for each charging session.

FIG. 6 shows an output speed graph 641 for the first charging session 640, an output speed graph 651 for the second charging session 650, and an output speed graph 661 for the third charging session 660, according to an embodiment. For example, referring to the graphs for charging sessions shown in FIG. 6, the output speeds may be differently calculated even if the battery of the same vehicle is charged three times.

According to an embodiment, the charger “L” 630 may calculate output data for each charging session. For example, the maximum value of the output speeds, the minimum value of the output speeds, or the mean value of the output speeds may be calculated. Thus, the maximum value of the output speeds, the minimum value of the output speeds, or the mean value of the output speeds may be calculated differently for the charging sessions.

According to an embodiment, output data 642 of the first charging session, output data 652 of the second charging session, and output data 662 of the third charging session may include different pieces of data.

For example, the maximum value of the output speeds for the first charging session 640 may be calculated as 50 kW and the mean value of the output speeds for the first charging session 640 may be calculated as 39.83 kW. The maximum value of the output speeds for the second charging session 650 may be 35 kW, and the mean value of the output speeds for the second charging session 650 may be 27.33 kW. The maximum value of the output speeds for the third charging session 660 may be 50 kW, and the mean value of the output speeds for the third charging session 660 may be 36 kW.

According to an embodiment, the charger “L” 630 may transmit, to a server 620, at least one of the output data 642 of the first charging session, the output data 652 of the second charging session, or the output data 662 of the third charging session, or any combination thereof.

According to an embodiment, the server 620 may store the output data 642 of the first charging session, the output data 652 of the second charging session, or the output data 662 of the third charging session in a database.

According to an embodiment, the server 620 may match the charging speed data received from the vehicle with the charger output data including the output data 642 of the first charging session, the output data 652 of the second charging session, or the output data 662 of the third charging session.

For example, the server 620 may compare the charger output data to the charging speed data to determine the performance of the charger. For example, if a difference between the output speed included in the charger output data and the actual charging speed of the battery included in the charging speed data exceeds a threshold, it may be determined that the performance of the charger has been reduced.

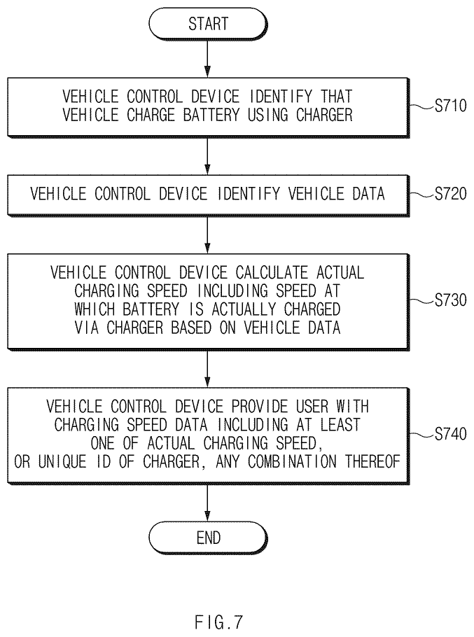

FIG. 7 is a flowchart for describing a vehicle control device, a server, or a vehicle control method according to an embodiment of the present disclosure.

Hereinafter, the vehicle control device 100 of FIG. 1 or the server 200 of FIG. 2 may perform the process of FIG. 7. Further, in the description of FIG. 7, operations described as being performed by the vehicle control device may be understood to be controlled by the first processor 110 of the vehicle control device 100 of FIG. 1, and operations described as being performed by the server may be understood to be controlled by the second processor 210 of the server 200 of FIG. 2.

According to an embodiment, the vehicle control device may identify that a vehicle is charging a battery using a charger (S710).

According to an embodiment, the vehicle control device may identify vehicle data (S720). The vehicle data may include a time when charging of the battery is started, an SOC (State of Charge) of a battery when charging is started, the capacity of the battery, a time when charging of the battery is ended, or an SOC of the battery when charging of the battery is ended, or any combination thereof.

According to an embodiment, the vehicle control device may calculate an actual charging speed including a speed at which the battery is actually charged by a charger, based on the vehicle data (S730).

According to an embodiment, the vehicle control device may provide a user with information about charging speed data, including at least one of the actual charging speed, or the unique ID of the charger, or any combination thereof, using at least one of the display of the vehicle or the audio device of the vehicle, or any combination thereof (S740).

According to an embodiment, the vehicle control device may transmit charging speed data to the server.

According to an embodiment, the server may receive the charging speed data transmitted by the vehicle and generate charger-specific charging speed data. According to an embodiment, the charger-specific charging speed data may include data matched with the actual charging speed, the unique ID of the charger, the date on which the charging speed data is received, and the time at which the charging speed data is received.

According to an embodiment, charger output data may be received from the charger. For example, the charger output data 331 may include at least one of the unique ID of the charger, the maximum value of the output speeds at which the charger outputs power during the entire charging time taken from the time when charging of the battery is started to the time when charging of the battery is ended, the minimum value of the output speeds at which the charger outputs power during the entire charging time, and an mean value of the output speeds at which the charger outputs power during the entire charging time, or any combination thereof.

According to an embodiment, the server may determine the performance of the charger by comparing the charger output data and the charging speed data.

According to an embodiment, the server may provide the user with information related to charger-specific charging speed data via at least one of the navigation system the vehicle, a mobile application, or a web page, or any combination thereof.

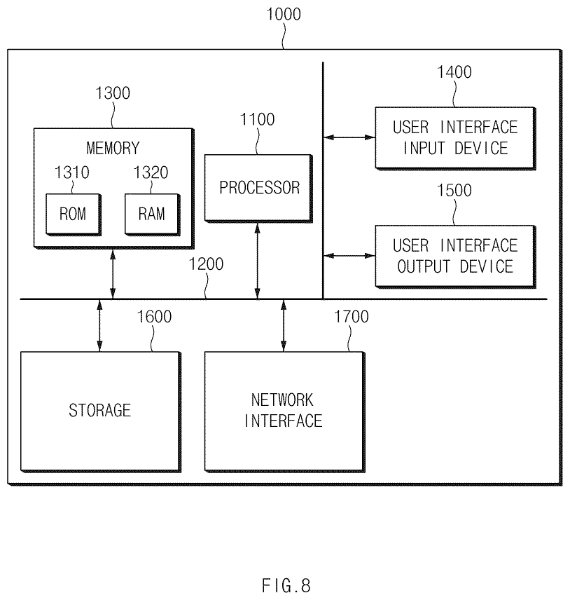

FIG. 8 is a diagram showing a computing system related to a vehicle control device, a sever or a vehicle control method according to an embodiment of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may collect information about a speed at which a vehicle battery is actually charged by each charger, and provide the user with information about an accurate charging speed for each charger based on the collected information.

The present technology may allow a user to more accurately estimate the time required to charge a vehicle battery using a corresponding charger by providing the user with information about a speed at which the vehicle battery is actually charged for each charger.

The present technology may collect information about a speed at which the battery of the vehicle is actually charged for each charger, and provide a user with information reflecting the charging speed that varies depending on a change in the age of the charger, season, weather, and/or the like.

The present technology may determine the performance of a charger by continuously updating information about a speed at which the battery of the vehicle is actually charged for each charger.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A vehicle control device comprising:
a memory soring computer-executable instructions; and
at least one processor configured to access the memory and execute the instructions, wherein the instructions comprise:
based on a vehicle charging a battery using a charger,
obtaining a unique ID of the charger;
identifying vehicle data including at least one of a time when charging of the battery is started, an SOC (State of Charge) of the battery when the charging of the battery is started, a capacity of the battery, a time when the charging of the battery is ended, or an SOC of the battery when the charging of the battery is ended, or any combination thereof;
calculating an actual charging speed including a speed at which the battery is actually charged by the charger based on the vehicle data; and
providing a user with information about charging speed data, including at least one of the actual charging speed or the unique ID of the charger, or any combination thereof using at least one of a display of the vehicle, or an audio device of the vehicle, or any combination thereof.

2. The vehicle control device of claim 1, wherein the instructions comprise calculating at least one of a maximum value of actual charging speeds calculated for cycles, a minimum value of the actual charging speeds calculated for cycles, or a mean value of the actual charging speeds calculated for cycles, or any combination thereof based on calculating the actual charging speed for each cycle between the time when the charging of the battery is started and the time when the charging of the battery is ended.

3. The vehicle control device of claim 1, wherein the instructions comprise calculating a mean value of the actual charging speeds over an entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery based on identifying that the actual charging speed for each cycle is not calculated, that the battery is charged while an engine of the vehicle is turned off, that the charging of the battery is ended abnormally, or that charging speed data is not transmitted to a server due to a communication failure, or any combination thereof.

4. The vehicle control device of claim 1, wherein the instructions comprise obtaining the unique ID of the charger from map data used to guide a path of the vehicle.

5. The vehicle control device of claim 1, wherein the instructions comprise:
transmitting the charging speed data to a server;
receiving charging speed data for each charger including data matching the actual charging speed, the unique ID of the charger, a date on which the server received the charging speed data, and a time at which the server received the charging speed data; and
providing the user with information about charger-specific charging speed data using at least one of the display of the vehicle, or the audio device of the vehicle, or any combination thereof.

6. A server comprising:
a memory storing computer-executable instructions; and
at least one processor configured to access the memory and execute the instructions, wherein the instructions comprise:
receiving, from a vehicle, charging speed data including at least one of an actual charging speed including a speed at which a battery of the vehicle is actually charged by a charger, or a unique ID of the charger, or any combination thereof; and
generating charger-specific charging speed data including data matched with the actual charging speed, the unique ID of the charger, a date on which the charging speed data is received, and a time at which the charging speed data is received.

7. The server of claim 6, wherein the instructions comprise matching external factor information including at least one of season, weather, external temperature, type of vehicle, age of vehicle, or age of charger, or any combination thereof, with the charger-specific charging speed data.

8. The server of claim 7, wherein the instructions comprise providing a user with information related to the charger-specific charging speed data via at least one of a navigation system of the vehicle, a mobile application, or a web page, or any combination thereof.

9. The server of claim 6, wherein the instructions comprise receiving the charging speed data from the vehicle, the charging speed data including actual charging speeds calculated for cycles, a maximum value of the actual charging speeds calculated for cycles, a minimum value of the actual charging speeds calculated for cycles, a mean value of the actual charging speeds calculated for cycles, a mean value of actual charging speeds over an entire charging time taken from a time when charging of the battery is started to a time when the charging of the battery is ended.

10. The server of claim 9, wherein the mean value of actual charging speeds over the entire charging time is calculated as a value obtained by dividing, by the entire charging time, a value obtained by multiplying a difference between an SOC of the battery at the time when the charging of the battery is ended and an SOC of the battery at the time when the charging of the battery is started, by a capacity of the battery.

11. The server of claim 6, wherein the instructions comprise:
identifying an entire charging time taken from a time when charging of the battery is started to a time when the charging of the battery is ended; and
receiving charger output data from the charger, the charger output data including at least one of the unique ID of the charger, a maximum value of output speeds at which the charger outputs power during the entire charging time, a minimum value of the output speeds at which the charger outputs power during the entire charging time, or a mean value of output speeds at which the charger outputs power during the entire charging time, or any combination thereof.

12. The server of claim 11, wherein the instructions comprise comparing the charger output data with the charging speed data to determine performance of the charger.

13. A vehicle control method comprising:
identifying, by a vehicle control device, that a vehicle charges a battery using a charger;
identifying, by the vehicle control device, vehicle data including a time when charging of the battery is started, an SOC (State of Charge) of a battery when the charging of the battery is started, a capacity of the battery, a time when the charging of the battery is ended, or an SOC of the battery when the charging of the battery is ended, or any combination thereof;
calculating, by the vehicle control device, an actual charging speed including a speed at which the battery is actually charged by the charger based on the vehicle data; and
providing, by the vehicle control device, a user with information about charging speed data, including at least one of the actual charging speed, or a unique ID of the charger, or any combination thereof using at least one of a display of the vehicle, or an audio device of the vehicle, or any combination thereof.

14. The vehicle control method of claim 13, wherein calculating the actual charging speed includes calculating, by the vehicle control device, at least one of a maximum value of actual charging speeds calculated for cycles, a minimum value of the actual charging speeds calculated for cycles, or a mean value of the actual charging speeds calculated for cycles, or any combination thereof based on calculating the actual charging speed for each cycle between the time at which the charging of the battery is started and the time at which the charging of the battery is ended.

15. The vehicle control method of claim 13, wherein calculating the actual charging speed includes
calculating, by the vehicle control device, a mean value of the actual charging speeds over an entire charging time by dividing, by the entire charging time taken from a time when charging of the battery is started to a time when the charging of the battery is ended, a value obtained by multiplying a difference between the SOC of the battery at the time when charging of the battery is ended and the SOC of the battery at the time when charging of the battery is started, by the capacity of the battery based on identifying that the actual charging speed for each cycle is not calculated, that the battery is charged while an engine of the vehicle is turned off, that the charging of the battery is ended abnormally, or that charging speed data is not transmitted to a server due to a communication failure, or any combination thereof.

16. The vehicle control method of claim 13, further comprising:
transmitting, by the vehicle control device, the charging speed data to a server;
receiving, by the server, the charging speed data from the vehicle; and
generating, by the server, charger-specific charging speed data including data matched with the actual charging speed, the unique ID of the charger, a date on which the charging speed data is received, and a time at which the charging speed data is received.

17. The vehicle control method of claim 16, wherein generating the charger-specific charging speed data includes matching, by the server, external factor information including at least one of season, weather, external temperature, type of vehicle, age of vehicle, or age of charger, or any combination thereof, with the charger-specific charging speed data.

18. The vehicle control method of claim 17, further comprising:
providing, by the server, the user with information related to the charger-specific charging speed data via at least one of a navigation system of the vehicle, a mobile application, or a web page, or any combination thereof.

19. The vehicle control method of claim 13, further comprising:
receiving, by a server, charger output data from the charger, the charger output data including at least one of the unique ID of the charger, a maximum value of output speeds at which the charger outputs power during an entire charging time taken from a time when charging of the battery is started to a time when the charging of the battery is ended, a minimum value of the output speeds at which the charger outputs power during the entire charging time, or a mean value of output speeds at which the charger outputs power during the entire charging time, or any combination thereof.

20. The vehicle control method of claim 19, further comprising:
comparing, by a server, the charger output data with the charging speed data to determine performance of the charger.
